(19) United States
(12) Patent Application Publication
(10) Pub. No.: US 2017/0029266 A1
(43) Pub. Date: Feb. 2, 2017

(54) Locator and Safety Halter

(71) Applicant: Laura Gay Statam, Export, PA (US)

(72) Inventor: Laura Gay Statam, Export, PA (US)

(21) Appl. No.: 15/007,358

(22) Filed: Jan. 27, 2016

Related U.S. Application Data
(60) Provisional application No. 62/199,314, filed on Jul. 31, 2015.

(51) Int. Cl. B68B 5/00; B68B 99/00

(52) U.S. Cl. CPC B68B 5/00; B68B 99/00

(57) ABSTRACT

A lighted horse halter includes a number of halter pieces and a portable electric power source is supported by one of the halter pieces. A light source supported by one of the halter pieces is responsive to electrical power received from the portable electric power source for outputting light. A side-glow optical fiber supported by one of the halter pieces is responsive to the light output by the light source for outputting light transverse to a side wall of the optical fiber. The optical fiber can be sandwiched between the nose band and a protective cover that can include fluorescent material.

### CROSS REFERENCE TO RELATED APPLICATION

This application claims the benefit of U.S. Provisional Application No. 62/199,314, filed Jul. 31, 2015, which is incorporated herein by reference.

### BACKGROUND OF THE INVENTION

Field of the Invention

The present invention relates to a lighted horse halter and, more particularly, to a horse halter that includes a battery powered light source to increase the visibility of a horse at night or in low lighting conditions.

Description of Related Art

At night or in low light conditions, it is difficult if not impossible to locate horses in a pasture under normal circumstances. Moreover, in times of natural or manmade disasters, such as floods or forest fires, it is not uncommon for horses to be set free in the hope that the horses can move freely and survive such disasters. A problem with locating a horse at night or in low light conditions, either in a pasture or when set free, is the ability to accurately locate the horse, either visually, electronically, or both visually and electronically.

### SUMMARY OF THE INVENTION

Various preferred and non-limiting examples or aspects of the present invention will now be described and set forth in the following numbered clauses:

Clause 1: A lighted horse halter comprises: halter pieces including a head piece, a nose band, a pair of cheek pieces in spaced relation between the nose band and the head piece, a throat latch between the cheek pieces, and a connecting strap between the nose band and the throat latch; a portable electric power source supported by one of the halter pieces; a light source supported by one of the halter pieces and responsive to electrical power received from the portable electric power source for outputting light; and a side-glow optical fiber supported by one of the halter pieces and responsive to the light output by the light source for outputting light transverse to a side wall of the optical fiber.

Clause 2: The lighted horse halter of clause 1, further including a protective cover covering the optical fiber.

Clause 3: The lighted horse halter of clause 1 or 2, wherein the protective cover comprises fluorescent material.

Clause 4: The lighted horse halter of any of clauses 1-3, wherein the optical fiber is sandwiched between the nose band and the protective cover.

Clause 5: The lighted horse halter of any of clauses 1-4, wherein the protective cover is made from ballistic nylon.

Clause 6: The lighted horse halter of any of clauses 1-5, further including a solar cell supported by one of the halter pieces and responsive to ambient light for charging the portable electric power source.

Clause 7: The lighted horse halter of any of clauses 1-6, further including a communications circuit supported by one of the halter pieces and operative for wirelessly transmitting a signal.

Clause 8: The lighted horse halter of any of clauses 1-7, wherein the signal includes a unique identifier that is programmed into the communications circuit.

Clause 9: The lighted horse halter of any of clauses 1-8, further including a GPS circuit operative for supplying the GPS coordinates of the halter to the communications circuit, wherein the signal includes the GPS coordinates.

Clause 10: The lighted horse halter of any of clauses 1-9, further including a light sensor responsive to ambient light for causing electrical power of the portable electric power source to be delivered to or withheld from the light source based on an intensity of the ambient light.

### BRIEF DESCRIPTION OF THE DRAWINGS

FIG. 1A is a first example lighted horse halter;

FIG. 1B is a cross-section taken along lines IB-IB in FIG. 1A;

FIG. 2 is a second example lighted horse halter;

FIG. 3 is a third example horse halter; and

FIG. 4 is a fourth example horse halter.

### DESCRIPTION OF THE INVENTION

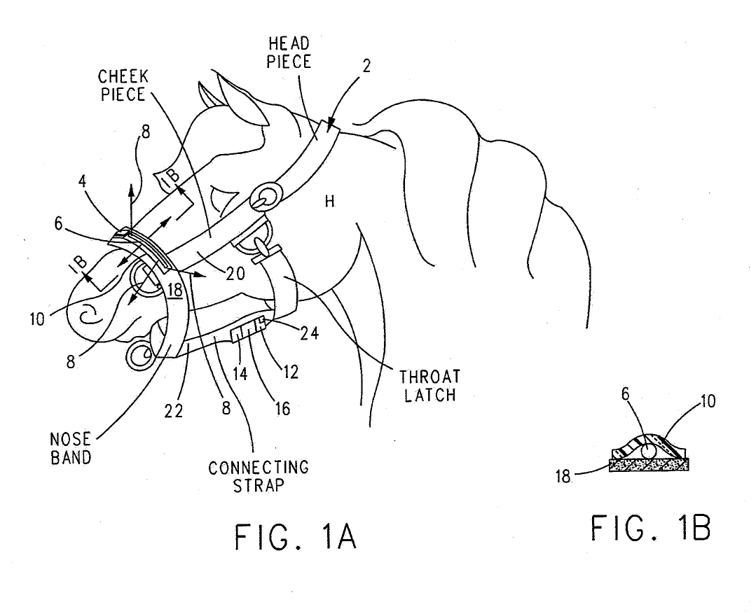

Disclosed herein is a method and apparatus to visually and/or electronically locate horses if they were to be loose on private or public lands and throughways with example devices described below with reference to the accompanying FIGS. 1-4 where like reference numbers correspond to like or functionally equivalent elements.

### Example 1

With reference to FIGS. 1A and 1B, a first example horse halter 2 includes one or more LEDs 4 that are operatively coupled to a side-view (or side glow) light-emitting optical fiber column (or cable) 6 that is configured to emit input LED light from each LED 4 transverse to a side wall of optical fiber column 6 (as shown by arrows 8). In an example shown in FIG. 1B, fiber optic column 6 is affixed (e.g., via an adhesive) to a noseband 18 of the halter 2 and can be covered with a ballistic nylon protective cover 10 that allows the light to pass through yet is durable to anticipated conditions. In an example, the ballistic nylon cover 10 comprises fluorescent material. In response to light from the optical fiber column 6 passing therethrough, the fluorescent material of ballistic nylon protective cover 10 emits light by the well-known process of fluorescence. In an example, LED 4 and optical fiber column 6 are desirably positioned on noseband 18 such that horse H cannot see the light output thereby. Each LED 4 can be powered by one or more batteries 12 and/or any other suitable and/or desirable source of portable electrical power.

An optional GPS circuit 14 (described further in Example 4) can be provided that is powered by the one or more batteries 12. GPS circuit 14 can be coupled to halter 2 to aid in locating halter 2 via its GPS coordinates via an application on a smartphone or computer (laptop, desktop, or pad), in a manner described hereinafter. GPS circuit 14 can include or can be operatively coupled to a communication circuit 16 that can be coupled to halter 2 and which can be configured and operative for wirelessly broadcasting or transmitting GPS data generated by GPS circuit 14 in a manner known in the art in a wireless signal via any known or hereinafter developed wireless protocol, including, but not limited to, cellular telephone, Wi-Fi, and/or Bluetooth. After suitable processing, e.g., via a cellular network, a Wi-Fi network, and/or a Bluetooth chip of a receiving device, such as a smartphone or computer (laptop, desktop, or pad), the GPS data embedded in the wireless signal can be displayed as an icon on a virtual map displayed on a display of a smartphone or computer in a manner known in the art to facilitate identifying the GPS location of halter 2 and, hence, horse H. An optional enclosure (not shown) can be provided to house any one or combination of batteries 12, GPS circuit 14, communications circuit 16, and on/off switch 24. This optional enclosure can be water and/or humidity tight.

In an example of halter 2 coupled to horse H, halter 2 includes two LEDs 4 located on a noseband portion 18 that extends, for example, between cheek pieces 20 (only one of which is shown in the figures). Across noseband portion 18 is disposed optical fiber column 6 with one LED 4 at each end. Optical fiber column 6 is configured to emit input LED light from LEDs 4 transverse to a side wall of optical fiber column 6 (as shown by arrows 8). The one or more batteries 12 can be located on a connecting strap 22 where batteries 12 are most protected against contact and moisture and as far from horse H as possible. The one or more batteries 12 can be coupled to a manually operated on/off switch 24 which can set as desired by a user. In an example, on/off switch 24 enables a user to selectively control the application or withholding of electrical power from batteries 12 to LEDs 4, GPS circuit 14, and/or communication circuit 16. Ballistic nylon protective cover 10 covering fiber optic column 6 of different instances of halter 2 used with different horses H can optionally be of different colors (fluorescent or not) to facilitate identifying different horses H via the different colors, where each horse H is optionally associated with a unique color and, optionally, GPS circuit 14.

In an example, batteries 12 and LEDs 4 are configured whereupon batteries have sufficient power to power LEDs to emit light for an extended period of time, for example, no less than 30 days. Batteries 12 can be one-time use batteries or can be rechargeable batteries.

### Example 2

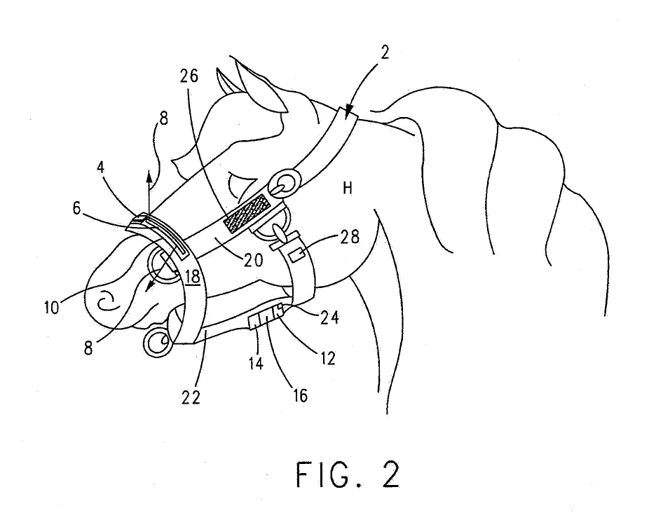

With reference to FIG. 2, in another example further or alternative to halter 2 described in Example 1 above, one or more solar cells 26 can be coupled to halter 2, e.g., to the exterior of one or both cheek pieces 20 of halter 2, to receive light and charge batteries 12 in a manner known in the art while maintaining a relatively safe location to avoid potential damage inflicted by horse H.

A light sensor 28, such as a photodiode, can be provided for causing LEDs 4 to receive power from batteries 12 upon light sensor 28 not detecting sufficient light and for causing LEDs 4 to not receive power from batteries 12 upon light sensor 28 detecting sufficient light. In an example, it is envisioned that the sensitivity of light sensor 28 can be selected or adjusted to a desired level of ambient light that causes LEDs 4 to receive power from batteries 12 or causes electrical power from batteries 12 to be withheld from LEDs 4. In an example, the sensitivity of light sensor 28 can be set whereupon power from batteries 12 is withheld from LEDs 4 when there is sufficient ambient light to see horse H in the ambient light without the aid of light output via optical fiber column 6 in response to illumination of the LEDs 4 with power from the batteries 12. In another example, the sensitivity of light sensor 28 can be set whereupon, when there is insufficient ambient light to see horse H, light sensor 28 can be operative for coupling LEDs 4 to receive electrical power from batteries 12. In an example, the capacity of batteries 12 can be selected to supply sufficient power to LEDs 4 to emit light to side view optical fiber column 6 for an extended period of time, for example, one day, or one week, or one or more months, without batteries 12 being recharged, e.g., from solar cells 26.

### Example 3

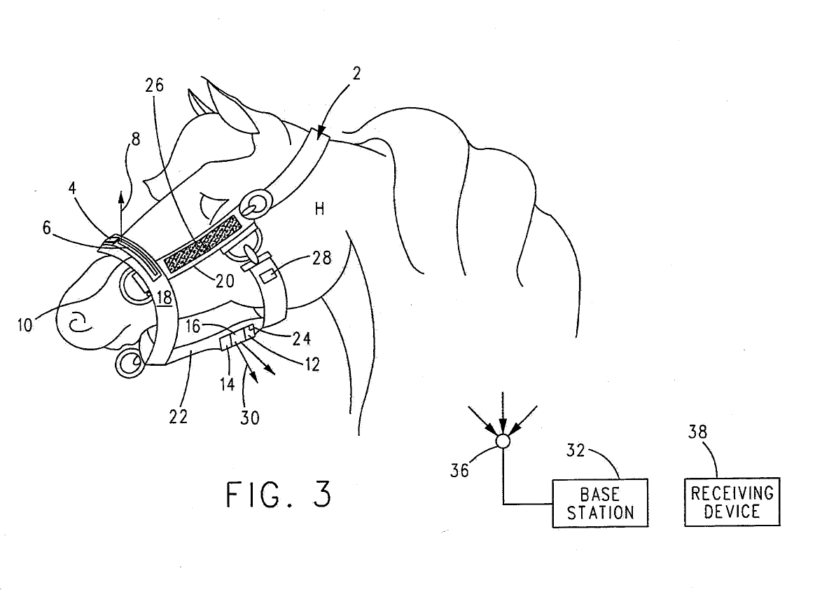

With reference to FIG. 3, in another example further or alternative to halter 2 described in any one or both of Examples 1 and 2 above, communications circuit 16 can include a wireless (RF) transmitter which can wirelessly broadcast signals 30 of any suitable and/or desirable frequency. In an example, these frequencies can include, without limitation, cellular telephone frequencies, RFID frequencies, FM frequencies, Wi-Fi frequencies, television broadcast frequencies, or any other suitable and/or desirable frequency capable of being transmitted without having a detrimental effect on horse H. These example frequencies, however, are not to be construed in a limiting sense.

In an example, a base station 32 can include or be coupled to receiving circuitry 36 that is operative for receiving (either directly or indirectly) the signals 30 output by communication circuit 16 and base station 32 can be programmed to periodically or aperiodically check whether a signal 30 from communication circuit has been received by receiving circuitry 36. In an example, receiving circuitry 36 is positioned within range of the signals 30 broadcast by communication circuit 16. However, this is not to be construed in a limiting sense.

In an example, base station 32 can be configured to check for the receipt of a signal 30 from communication circuit 16 on a preprogrammed interval or period, for example, every 5 minutes, 10 minutes, ½ hour, one hour, or any other suitable and/or desirable interval. Correspondingly, communication circuit 16 can be programmed to output a signal 30 at least once every said interval or period. Upon determining that a signal 30 from communication circuit 16 has been received during any predetermined interval or period, base station 32 takes no action. In contrast, if the signal 30 is not received during the predetermined interval or period, indicative of a failure of communication circuit 16 to transmit signal 30 or communication circuit 16 and, hence, horse H moving out of range of receiving circuitry 36 coupled to the base station 32, base station 32 can generate an alarm signal.

This alarm signal can be communicated by base station 32 via a wired and/or wireless connection to one or more receiving devices 38, such as a smartphone or computer (laptop, desktop, or pad) which can be programmed to convert the alarm signal from base station 32 into an audible and/or visual display associated with the alarm signal thereby acting to notify a user of each receiving device 38 that a communication circuit 16 coupled to an issued halter 2 and, hence, horse H wearing halter 2, may be outside of an acceptable perimeter.

In an example, base station 32 can be used to monitor halters on multiple horses H. In this example, the communication circuit 16 of each halter 2 can be programmed with a unique identifier that can be modulated onto signal 30 output by said communication circuit 16, which unique identifier can be forwarded by base station 32 to the one or more receiving devices 38 to facilitate a user(s) thereof determining which communication circuit 16 coupled to halter 2 and, hence, horse H, is within or outside of the range of receiving circuitry 36 in the manner described above.

In an example, base station 32 can optionally be programmed with the unique identifier of each communication circuit 16 coupled to a halter 2 to be monitored by base station 32 whereupon in the absence of receiving a signal 30 within the predetermined interval or period, base station 32 can generate an alarm. However, this is not to be construed in a limiting sense since it is envisioned that base station 32 can be operative for processing and reporting any unique identifier received by base station 32 and if a unique identifier is received in one predetermined interval or period and not in another, base station 32 can generate an alarm signal.

Thus, communication circuit 16 of each halter 2 can be programmed with a unique identifier associated with horse H being monitored. Communication circuit 16 can periodically or aperiodically broadcast wireless signal 30 that can include the unique identifier. Receiving circuitry 36 associated with base station 32 can be configured to receive (directly or indirectly) the signal 30 output by each communication circuit 16. In response to receiving the signal 30 output by a particular communication circuit 16 within the preprogrammed interval or period, base station 32 can be programmed to interpret this receipt as horse H associated with the unique identifier being within the range of receiving circuitry 36 and, hence, within an acceptable perimeter of receiving circuitry 36. However, if base station 32 does not receive signal 30 from a particular communication circuit 16 within the preprogrammed interval or period of time, base station 32 can be configured to interpret this as horse H associated with the unique identifier being monitored being outside of the acceptable perimeter of receiving circuitry 36 or, alternatively, a failure of the communication circuit 16 to broadcast the signal 30.

### Example 4

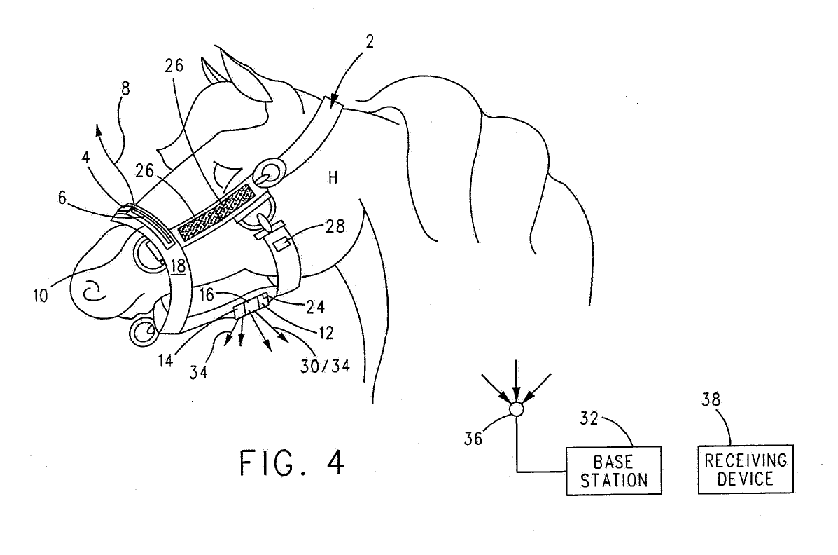

With reference to FIG. 4, in an example further or alternative to halter 2 described in any one or all of Examples 1-3, halter 2 can include GPS circuit 14 that can be configured to continuously, periodically, or aperiodically broadcast via communication circuit 16 one or more signals 30 that include GPS coordinates 34 of halter 2 to base station 32 via receiving circuitry 36. In this example, base station 32 or receiving circuitry 36 can be configured to decode GPS coordinates 34 of halter 2 from signals 30 received by receiving circuitry 36, which signals 30 can also include a unique identifier associated with halter 2. The decoded GPS coordinates 34 and, optionally, the unique identifier, can then be forwarded to a suitable receiving device, e.g., a smartphone or computer, in any suitable and/or desirable manner, for example, via a wired or wireless communication channel or connection, for receipt and analysis by a user of the receiving device. In an example, the receiving device can display the GPS coordinates of the halter as an icon associated with the halter on a virtual map and can optionally display as part of the icon (e.g., the color of the icon) or adjacent the icon the unique identifier associated with the halter.

Various aspects and features have been described with reference to the foregoing examples. Obvious modifications and alterations will occur to others upon reading and understanding the foregoing examples. It is intended that the examples be construed broadly as including all such modifications and alterations.

The invention claimed is:

1. A lighted horse halter comprising:
halter pieces including a head piece, a nose band, a pair of cheek pieces in spaced relation between the nose band and the head piece, a throat latch between the cheek pieces, and a connecting strap between the nose band and the throat latch;
a portable electric power source supported by one of the halter pieces;
a light source supported by one of the halter pieces and responsive to electrical power received from the portable electric power source for outputting light; and
a side-glow optical fiber supported by one of the halter pieces and responsive to the light output by the light source for outputting light transverse to a side wall of the optical fiber.

2. The lighted horse halter of claim 1, further including a protective cover covering the optical fiber.

3. The lighted horse halter of claim 2, wherein the protective cover comprises fluorescent material.

4. The lighted horse halter of claim 2, wherein the optical fiber is sandwiched between the nose band and the protective cover.

5. The lighted horse halter of claim 2, wherein the protective cover is made from ballistic nylon.

6. The lighted horse halter of claim 1, further including a solar cell supported by one of the halter pieces and responsive to ambient light for charging the portable electric power source.

7. The lighted horse halter of claim 1, further including a communications circuit supported by one of the halter pieces and operative for wirelessly transmitting a signal.

8. The lighted horse halter of claim 7, wherein the signal includes a unique identifier that is programmed into the communications circuit.

9. The lighted horse halter of claim 7, further including a GPS circuit operative for supplying the GPS coordinates of the halter to the communications circuit, wherein the signal includes the GPS coordinates.

10. The lighted horse halter of claim 1, further including a light sensor responsive to ambient light for causing electrical power of the portable electric power source to be delivered to or withheld from the light source based on an intensity of the ambient light.
